(19) United States
(12) Patent Application Publication
(10) Pub. No.: US 2011/0282793 A1
(43) Pub. Date: Nov. 17, 2011

(54) CONTEXTUAL TASK ASSIGNMENT BROKER

(75) Inventors: Marc Mercuri, Bothell, WA (US); James Oliver Tisdale, III, Duvall, WA (US)

(73) Assignee: MICROSOFT CORPORATION, Redmond, WA (US)

(21) Appl. No.: 12/779,785

(22) Filed: May 13, 2010

(51) Int. Cl. G06Q 30/00; G06Q 99/00; G06Q 20/00; G06Q 10/00

(52) U.S. Cl. 705/80; 705/14.16; 705/14.23; 705/347

(57) ABSTRACT

An automated broker provides contextual assignment of tasks. Service providers send the broker service provisioning information indicating the services they provide, with bids for referrals. Service consumers send the broker service requests, including criteria which the broker matches against the service provisioning information. The broker selects a recommended service provider, based on the service request's criteria, the referral bids, and reviews of the candidate service providers. Service request criteria may include a service provider's reputation in the consumer's social network, geographic proximity of the service provider to the location of the task, particular skills or experience of the service provider, the service provider's availability, and price. After a predetermined number of task assignment rejections by a service provider, a human administrator is notified. A referral bid payment or other payment made by the recommended service provider to the broker, may be shared with the service consumer.

BACKGROUND

Attempts to match people with tasks occur in a wide variety of contexts, using a wide variety of approaches. For example, many organizations use dispatchers to relay information and coordinate operations, such as police and fire departments, emergency medical services, military, towing services, taxicab providers, trucking companies, airports, train stations, and public utilities. Online job boards and classified ad sites help people who are seeking work find projects or positions that match their skills and location, and also help employers and individuals find qualified workers. Many employment websites allow employers to post job requirements, and some publish reviews of the employers. Some web sites publish reviews of service companies by people who have hired the companies.

Crowdsourcing web sites publish invitations to provide a service, such as developing a new technology or creating a design, for example. Problems are broadcast to a group of people, as an open call for solutions. Interested people (the “crowd”) may organize themselves into online communities, and the crowd submits proposed solutions. The crowd may also scrutinize proposed solutions and choose the ones that are collectively considered best. These best solutions become the property of the entity that broadcast the problem, and the people who provided them are sometimes rewarded, with cash, prizes, and/or public recognition.

It will be understood that crowdsourcing, employment websites, classified ad sites, human dispatchers, and the other examples noted above are not meant to be comprehensive. Other attempts to match people with tasks may also provide context or otherwise be of interest. It will also be understood that this Background was written with the embodiments discussed hereafter already in mind, and hence may provide groupings or suggest connections that would not have been apparent without such hindsight.

### SUMMARY

Online ad sites, job boards, and other resources provide an enormous amount of information, which may be helpful when searching for someone to provide a particular service, but may also be overwhelming. Focusing on certain contextual aspects of such a situation improves the probability that a service will be provided as desired.

Some embodiments provide contextual assignment of tasks through a partially or fully-automated broker. Service providers electronically send the broker service provisioning information indicating the services they provide, with referral bids indicating what the service provider will pay for a referral from the broker. Service consumers electronically send the broker service requests, including criteria which the broker matches against the service provisioning information to determine a set of candidate service providers. The broker selects a recommended service provider from among the candidate service providers, based on contextual data such as the service request's criteria, the referral bids, and reviews of the candidate service providers. In particular, reviews by fellow members of a social network of the service consumer may be a factor, but these and other reviews are not necessarily displayed to service consumers who did not write them. The broker sends a recommendation to the service consumer referring the service consumer to the recommended service provider, or to several recommended providers, who may be ranked by recommendation strength. The recommendation may recite the criteria in the service request, along with the matching service provisioning information of the recommended service provider(s).

Service request criteria used in determining a set of candidate service providers may include, for example, a service provider's reputation value based on reviews by a community of service consumers (in the consumer's specified social network, for example), or a service provider's reputation value based on a rating issued by an organization such as a chamber of commerce or a regulatory agency. Service request criteria may also include the geographic proximity of the service provider to the location of the task, particular skills or experience of the service provider, and the service provider's availability. Criteria used may also include an ask price, namely, a price the service provider is asking to be paid by the service consumer, and an offer price, namely, a price the service consumer is offering to pay for the service.

Service provider recommendations may be accepted or rejected by consumers. Similarly, task assignments sent by the broker may be accepted or rejected by the service providers who receive them. Criteria for accepting or rejecting assignments in general, or a particular assignment, may be recited in a response to an assignment. After a predetermined number of task assignment rejections by a service provider, some embodiments automatically notify a human administrator, who may investigate and take appropriate action.

In some embodiments, payments are made before, during, and/or after services are provided. For example, a referral bid payment or other payment may be made by the recommended service provider to the broker, and in some cases, this payment is shared by the broker with the service consumer. The service consumer may also pay the service provider, and may pay the broker. Coupons and discount codes may be redeemable with the service provider.

The examples given are merely illustrative. This Summary is not intended to identify key features or essential features of the claimed subject matter, nor is it intended to be used to limit the scope of the claimed subject matter. Rather, this Summary is provided to introduce—in a simplified form—some concepts that are further described below in the Detailed Description. The innovation is defined with claims, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating a computer system having at least one processor and at least one memory, and other items in an operating environment which may be present on multiple network nodes, and also illustrating configured storage medium embodiments;

FIG. 2 is a block diagram illustrating aspects of a contextual task assignment broker architecture;

FIG. 3 is a flow chart illustrating steps of some process and configured storage medium embodiments, from the perspective of a contextual task assignment broker;

FIG. 4 is a data flow diagram illustrating contextual task assignment in an example architecture, from a third-person perspective;

FIG. 5 is a flow chart illustrating steps of some process and configured storage medium embodiments, from a third-person perspective, in which a service provider becomes known to a contextual task assignment broker; and

FIG. 6 is a flow chart illustrating steps of some process and configured storage medium embodiments, from a third-person perspective, in which a service request is contextually processed through to service completion.

### DETAILED DESCRIPTION

Overview

Services from initially unidentified but qualified people are desired in a wide variety of situations. A news organization may want video and local information after a natural disaster, military coup, uprising, or other event in a location far from the news organization's current staff. An individual who is traveling may want to find someone nearby to help change a flat tire, or diagnose and correct a misbehaving laptop computer. One may desire or need the services of a hair stylist with an open appointment, or a mechanic with an opening to look at a car problem for a child who is located in another state. A person living in one state but looking for a home in another state may be seriously considering making an offer for a particular property, and thus want someone qualified and reliable to go look at it and report back within the next two hours. Of course, these are but a few of the many possible examples of situations in which it is desirable to find a service provider outside of one's established set of familiar contacts.

To address service requests, some embodiments utilize contextual data such as reputation and geographic proximity while automatically requesting the engagement of service providers. When a consumer (individual or entity) initiates a request, their geo-location is identified and used to identify potential task assignees of high reputation who are also physically nearby and can accept the task. For example, a request for information about a news-worthy event might lead to identification of staff reporters and subject matter experts who are near the event and available to assist reporting on it. A similar approach may be used in other situations, such as assigning medical personnel in an emergency, or dispatching a service technician to a customer.

An embodiment may also utilize other consumer criteria and contextual information, such as provider skills, experience, and cost. Some embodiments factor in a referral fee. Some embodiments utilize aspects of crowdsourcing. In particular, a pool of potential assignees can include an organization's staff as well as volunteer members of a crowdsourced community.

Reference will now be made to exemplary embodiments such as those illustrated in the drawings, and specific language will be used herein to describe the same. But alterations and further modifications of the features illustrated herein, and additional applications of the principles illustrated herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage, in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise their right to their own lexicography. Terms may be defined, either explicitly or implicitly, here in the Detailed Description and/or elsewhere in the application file.

As used herein, a “computer system” may include, for example, one or more servers, motherboards, processing nodes, personal computers (portable or not), personal digital assistants, cell or mobile phones, and/or device(s) providing one or more processors controlled at least in part by instructions. The instructions may be in the form of software in memory and/or specialized circuitry.

In particular, although it may occur that many embodiments run on workstation or laptop computers, other embodiments may run on other computing devices, and any one or more such devices may be part of a given embodiment.

A “multithreaded” computer system is a computer system which supports multiple execution threads. The term “thread” should be understood to include any code capable of or subject to synchronization, and may also be known by another name, such as “task,” “process,” or “coroutine,” for example. The threads may run in parallel, in sequence, or in a combination of parallel execution (e.g., multiprocessing) and sequential execution (e.g., time-sliced). Multithreaded environments have been designed in various configurations. Execution threads may run in parallel, or threads may be organized for parallel execution but actually take turns executing in sequence. Multithreading may be implemented, for example, by running different threads on different cores in a multiprocessing environment, by time-slicing different threads on a single processor core, or by some combination of time-sliced and multi-processor threading. Thread context switches may be initiated, for example, by a kernel's thread scheduler, by user-space signals, or by a combination of user-space and kernel operations. Threads may take turns operating on shared data, or each thread may operate on its own data, for example.

A “logical processor” or “processor” is a single independent hardware thread-processing unit. For example a hyperthreaded quad core chip running two threads per core has eight logical processors. Processors may be general purpose, or they may be tailored for specific uses such as graphics processing, signal processing, floating-point arithmetic processing, encryption, I/O processing, and so on.

A “multiprocessor” computer system is a computer system which has multiple logical processors. Multiprocessor environments occur in various configurations. In a given configuration, all of the processors may be functionally equal, whereas in another configuration some processors may differ from other processors by virtue of having different hardware capabilities, different software assignments, or both. Depending on the configuration, processors may be tightly coupled to each other on a single bus, or they may be loosely coupled. In some configurations the processors share a central memory, in some they each have their own local memory, and in some configurations both shared and local memories are present.

“Kernels” include operating systems, hypervisors, virtual machines, and similar hardware interface software.

“Code” means processor instructions, data (which includes constants, variables, and data structures), or both instructions and data.

“Automatically” means by use of automation (e.g., general purpose computing hardware configured by software for specific operations discussed herein), as opposed to without automation. In particular, steps performed “automatically” are not performed by hand on paper or in a person's mind; they are performed with a machine.

“Service provider” means a person or entity which has provided, is providing, or is offering to provide, a service. In particular, one can be a service provider even though one has not yet actually provided any service. Likewise, “service consumer” means a person or entity which has consumed, is consuming, or is seeking to consume, a service, and one can be a service consumer even though one has not yet actually received or otherwise consumed a service.

Throughout this document, use of the optional plural “(s)” means that one or more of the indicated feature is present. For example, “provider(s)” means “one or more providers” or equivalently “at least one provider”.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a step involving action by a party of interest such as “transmitting to”, “sending toward”, or “communicating to” a destination may involve intervening action such as forwarding, copying, uploading, downloading, encoding, decoding, compressing, decompressing, encrypting, decrypting and so on by some other party, yet still be understood as being performed directly by the party of interest.

Whenever reference is made to data or instructions, it is understood that these items configure a computer-readable memory thereby transforming it to a particular article, as opposed to simply existing on paper, in a person's mind, or as a transitory signal on a wire, for example.

Operating Environments

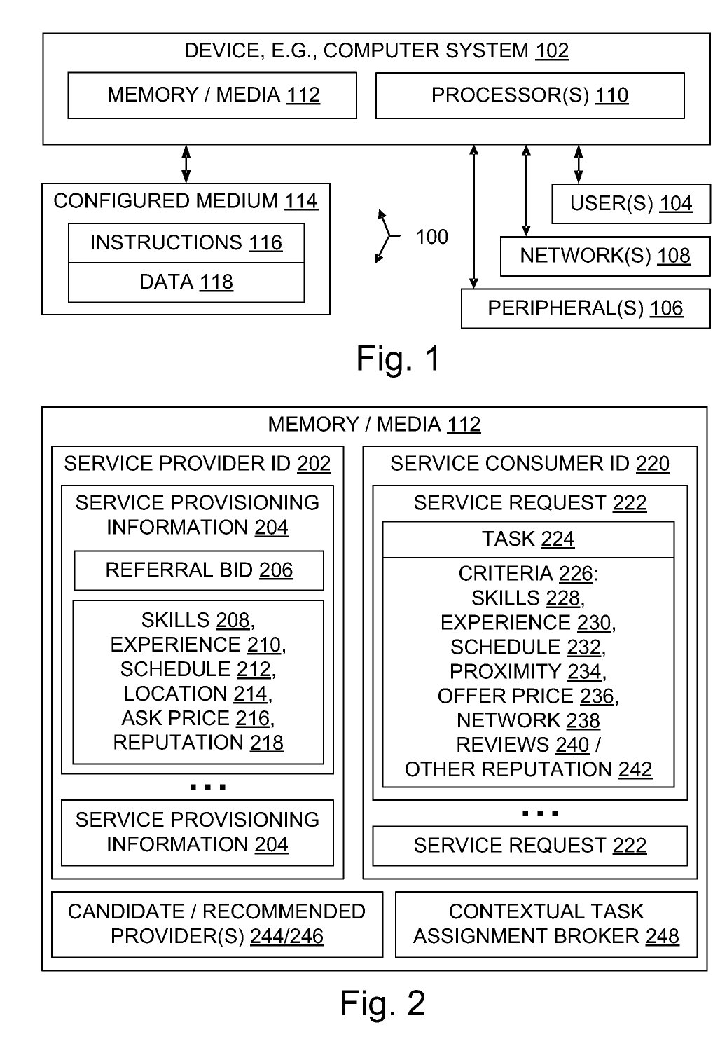

With reference to FIG. 1, an operating environment 100 for an embodiment may include a computer system 102. The computer system 102 may be a multiprocessor computer system, or not. An operating environment may include one or more machines in a given computer system, which may be clustered, client-server networked, and/or peer-to-peer networked.

Human users 104 may interact with the computer system 102 by using displays, keyboards, and other peripherals 106. System administrators, developers, engineers, and end-users are each a particular type of user 104. Automated agents acting on behalf of one or more people may also be users 104. Storage devices and/or networking devices may be considered peripheral equipment in some embodiments. Other computer systems not shown in FIG. 1 may interact with the computer system 102 or with another system embodiment using one or more connections to a network 108 via network interface equipment, for example.

The computer system 102 includes at least one logical processor 110. The computer system 102, like other suitable systems, also includes one or more computer-readable non-transitory storage media 112. An operating environment may also include other hardware, such as displays, buses, power supplies, and accelerators, for instance. Service provider software and data, service consumer software and task assignment broker software and data, a consumer dashboard, other software and data, and other items shown in the Figures and/or discussed herein may reside partially or entirely within one or more media 112, thereby configuring those media.

Media 112 may be of different physical types. The media 112 may be volatile memory, non-volatile memory, fixed in place media, removable media, magnetic media, optical media, and/or of other types of non-transitory media (as opposed to transitory media such as a wire that merely propagates a signal). In particular, a configured medium 114 such as a CD, DVD, memory stick, or other removable non-volatile memory medium may become functionally part of the computer system when inserted or otherwise installed, making its content accessible for use by processor 110. The removable configured medium 114 is an example of a computer-readable storage medium 112. Some other examples of computer-readable storage media 112 include built-in RAM, ROM, hard disks, and other storage devices which are not readily removable by users 104.

The medium 114 is configured with instructions 116 that are executable by a processor 110; “executable” is used in a broad sense herein to include machine code, interpretable code, and code that runs on a virtual machine, for example. The medium 114 is also configured with data 118 which is created, modified, referenced, and/or otherwise used by execution of the instructions 116. The instructions 116 and the data 118 configure the medium 114 in which they reside; when that memory is a functional part of a given computer system, the instructions 116 and data 118 also configure that computer system. In some embodiments, a portion of the data 118 is representative of real-world items such as physical locations, equipment, medical conditions, medicines, cars, homes, product characteristics, inventories, physical measurements, settings, images, readings, targets, volumes, and so forth. Such data is also transformed by as discussed herein, e.g., by selection, ranking, matching, accepting, rejecting, sharing, deriving, deployment, execution, modification, display, creation, loading, and/or other operations.

Systems

FIG. 2 illustrates aspects of an architecture for brokered contextual task assignment, which is suitable for use with some embodiments. Service providers are identified in systems and devices by service provider IDs 202, such as numeric IDs having associated alphanumeric contact information (name, address, web site domain, email address, phone, fax, etc.). Each service provider offers to provide service(s), which may have textual or multimedia descriptions and have associated service provisioning information 204.

Although only one service provider ID is shown for convenience of illustration, an embodiment may include one or more service provider IDs corresponding to one or more real-world service providers. The mapping between IDs and service providers is not necessarily one-to-one. A person may offer services in two different fields, for example, and thus have multiple IDs 202. Likewise, a given service may be a joint effort of several entities, which share a single ID 202 for convenience.

FIG. 2 shows each service provisioning information 204 structure as part of a record or other data structure containing the service provider ID 202. This illustrated organization could be implemented, for example, as a list of service provider IDs, each of which has a list of service provisioning information record(s) for the service(s) offered by that provider. However, the data may be organized in other structures, such as a relational database having a service providers table with ID 202 entries and related provisioning information tables containing provisioning information 204 entries. Trees, lists, objects, classes, hash tables, and other familiar data structures may be adapted for use in implementations.

The number of copies of particular pieces of data may vary across different implementations. For instance, one implementation includes a set of structs, records, or objects, each of which contains a service provider ID 202 and service provisioning information 204 for a single service. Accordingly, it will be appreciated that in some implementations a given service provider ID appears only once even when the provider in question offers multiple services, while in other implementations several copies of the ID appear even though the same functionality is present from a user perspective.

In the illustrated architecture, service provisioning information 204 includes a referral bid 206, namely, an amount the service provider is willing to pay a broker for being referred to a consumer through the broker. The referral bid may be a simple monetary amount, or it may be conditional, e.g., payment may depend on whether the service provider is paid, on how much the service provider is paid, on whether the consumer maintains a subscription or other relationship with the service provider, and so on. A referral bid may also specify an amount the broker is to share with the consumer.

In the illustrated architecture, service provisioning information 204 also includes descriptions of service provider skills 208, experience 210, availability schedule 212, and serviced location(s) 214. An ask price 216 states the price the service provider is asking for its service. Items 208-216 will generally be provided by the service provider.

In contrast, a reputation 218 value is generally calculated by a broker or third party, rather than being supplied directly by the service provider. For instance, a reputation value may be based on reviews and/or other feedback from all participating consumers of the service provider, on feedback from all recent (within a specified time period) participating consumers of the service provider, and/or on feedback from all participating consumers of the service provider who belong to specified social network(s). A reputation value may also be based on a rating from some organization, such as a business bureau, consumer advocacy organization, chamber of commerce, regulatory or licensing authority, or trade association, for example.

Turning now to the service consumer side of FIG. 2, service consumers are identified in systems and devices by service consumer IDs 220, such as numeric IDs with associated alphanumeric contact information (name, address, web site domain, email address, phone, fax, etc.). The mapping between consumer IDs and real-world service consumers is not necessarily one-to-one. For example, several entities may jointly submit a service request, using a shared ID 220 for convenience. Likewise, a given entity or individual may use several consumer IDs, for accounting convenience or other reasons.

At a given point in time, a service consumer has zero or more pending requests 222 for service(s) in the form of task(s) 224, which may have textual or multimedia descriptions and have associated service criteria 226. For convenient illustration, FIG. 2 shows one task 224 per service request 222, and one or more service requests 222 per service consumer ID 220. However, as with the service provider data, these service consumer data may be implemented using a variety of data structures, such as trees, lists, objects, classes, hash tables, database records, structs, and other familiar data structures. The number of copies of particular pieces of data may likewise vary across different implementations.

As indicated by their names, some service request criteria 226 correspond with service provisioning information 204. Thus, skills 228 requested corresponds with skills 208 offered, experience 230 requested corresponds with experience 210 offered, schedule 232 requested corresponds with availability schedule 212 offered, and proximity 234 requested corresponds with location(s) 214 offered. Service request offer price 236 is the price a consumer is willing (at least prior to negotiation) to pay for the requested service, and thus corresponds with the ask price 216, the price the provider is asking to be paid. Minimum acceptable reviews 240, possibly in specified social network(s) 238, or other minimally acceptable reputation 242 values in a service request, correspond with the service provider's reputation 218 value(s) in the service provisioning information 204. It will be understand that “corresponds” is used here in the sense that an item in a request 222 indicates a desired or required qualification to be compared with the indicated corresponding offered qualifications when determining whether a service provider is acceptable as a candidate to provide a requested service.

In operation, an embodiment may help a consumer find the most qualified nearby provider who is willing to perform a task 224. In some embodiments, an arbitrarily large number of individuals may be opt-in participants to an embodiment. As part of an opt-in procedure, participants identify their credentials, background, areas of interest, geographic location 214, 234, and so on. When a service is requested, an embodiment identifies which member providers are good candidates 244 and then communicates with them about possible task assignments, by using voice, email, SMS text message, mobile phone applications, and/or other network 108 communication mechanisms. When computers, phones, or other geo-locatable devices 102 are involved, applications can regularly poll or be polled to determine the location of the individual. Based on criteria 226 such as skillset, background, location, and reputation, a list of recommended providers 246 can be sent by an automated broker 248 to the person requesting service. If the requester approves (implicitly or explicitly), then recommended individuals can be offered a task assignment, and then choose to accept or reject it.

In some embodiments, performance records are stored in a reputation 218 system for each engagement. Over time, a given consumer can assign its top providers in a given location. In some embodiments, consumers can also look at relevant metadata in assignments, such as an indication in a provider's background that the provider is multilingual and ideal for both presenting on live TV and speaking to specified populations in the native language during an interview.

Some embodiments are compatible with other approaches to matching people with tasks, but through the broker 248 provide different functionality in a different way than these other approaches. Examples of such approaches may include, for a given embodiment, an email from person A to person B asking B to assign someone to help A get some particular job done, an electronic classified ad site, an employment service or other job board, software that scans resumes and automatically matches candidates with job postings, technology used to locate and/or dispatch police and other emergency or military personnel, and familiar crowd-sourcing technology. Some embodiments include aspects of such approaches, but differ in ways that will be apparent to those skilled in the art(s).

With reference to FIGS. 1 and 2, some embodiments provide a device or computer system 102 with a logical processor 110 and a memory medium 112 configured by circuitry, firmware, and/or software to transform service request context into service task assignments and results as described herein. In some embodiments, a memory in operable communication with the logical processor contains (and thus is configured into a special-purpose manufacture by) service provisioning information 204 for each of a plurality of service providers, bids 206 from the service providers indicating respective amounts the service provider will pay for a referral, and service request(s) 222 from a service consumer. Each service request contains service criteria 226. The memory is also configured by a contextual task assignment broker 248 that is operable to determine a set of candidate 244 service providers and produce a selection of a recommended service provider 246 from among the candidate service providers. In some embodiments, the contextual task assignment broker 248 is operable to determine a set of candidate service providers at least in part by eliminating lowest-bid 206 service provider(s) from being candidates 244.

In some embodiments, the memory also contains a social network 238 identification, and reviews 240 of the recommended service provider 246 by members of the social network. In such cases, the service criteria 226 may specify that the provider reputation 218 meet or exceed a minimum acceptable service provider reputation 242 value which is derived from the reviews. Consumers thus have an option of segregating reviews according to social network 238. The social network 238 may be implemented as an established public online social network, or as a list provided by the consumer, such as a list of the consumer's friends and family members. In this manner, a consumer may request, for instance, an electrician that is not only technically fit but also recommended by people whose judgment the consumer trusts.

In some embodiments, the service criteria 226 include one or more of the following: a service provider reputation 242 value derived from reviews 240 by a community of service consumers; a service provider reputation 242 value derived from a rating issued by an organization; a geographic proximity 234 of the service provider to a task location 214; particular skills of the service provider; particular experience of the service provider; an availability schedule of the service provider.

In some embodiments peripherals 106 such as human user I/O devices (screen, keyboard, mouse, tablet, microphone, speaker, motion sensor, etc.) will be present in operable communication with one or more processors 110 and memory. However, an embodiment may also be deeply embedded in a system, such that no human user 104 interacts directly with the embodiment. Software processes may be users 104.

In some embodiments, the system includes multiple computers connected by a network. Networking interface equipment can provide access to networks 108, using components such as a packet-switched network interface card, a wireless transceiver, or a telephone network interface, for example, will be present in a computer system. However, an embodiment may also communicate through direct memory access, removable nonvolatile media, or other information storage-retrieval and/or transmission approaches, or an embodiment in a computer system may operate without communicating with other computer systems.

Some embodiments operate in a “cloud” computing environment and/or a “cloud” storage environment. For example, service provisioning information 204 and service requests 222 may reside on some devices/systems 102 in a networked cloud, reputation values and reviews may be stored on yet other devices within the cloud, and the task assignment broker 248 may operate on yet other cloud device(s)/system(s) 102.

Processes

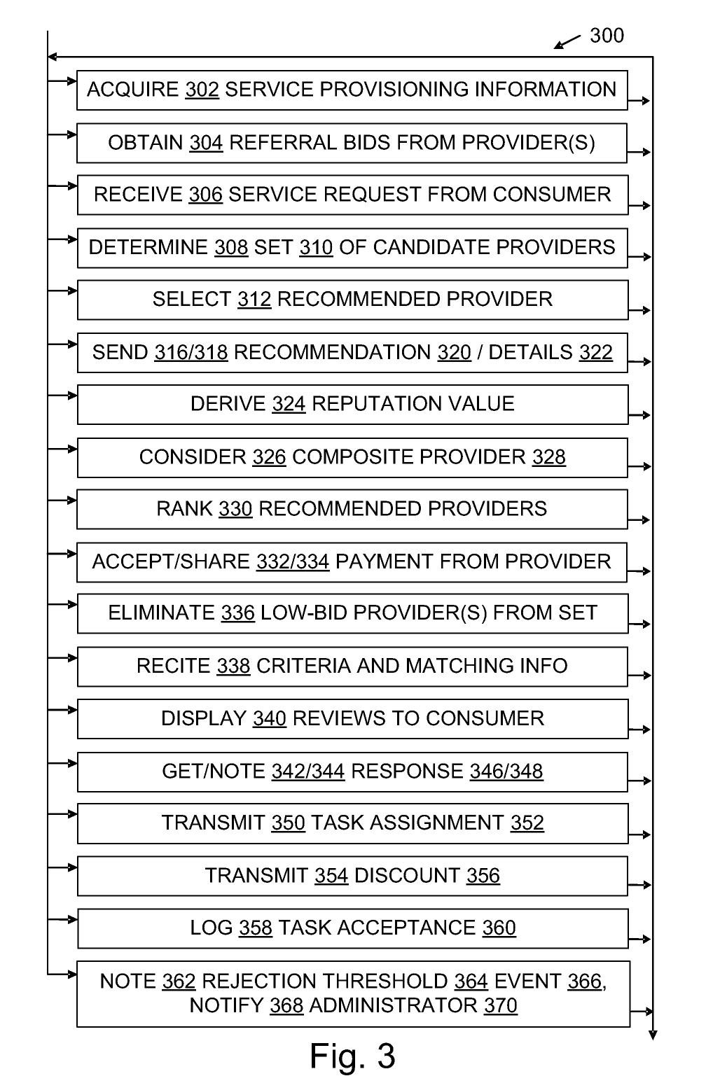

FIG. 3 illustrates some process embodiments in a flowchart 300. Processes shown in the Figures may be performed in some embodiments automatically, e.g., by a contextual task assignment broker 248 under control of a script requiring little or no user input. Processes may also be performed in part automatically and in part manually unless otherwise indicated. In a given embodiment zero or more illustrated steps of a process may be repeated, perhaps with different parameters or data to operate on. Steps in an embodiment may also be done in a different order than the top-to-bottom order that is laid out in FIG. 3. Steps may be performed serially, in a partially overlapping manner, or fully in parallel. The order in which flowchart 300 is traversed to indicate the steps performed during a process may vary from one performance of the process to another performance of the process. The flowchart traversal order may also vary from one process embodiment to another process embodiment. Steps may also be omitted, combined, renamed, regrouped, or otherwise depart from the illustrated flow, provided that the process performed is operable and conforms to at least one claim.

Examples are provided herein to help illustrate aspects of the technology, but the examples given within this document do not describe all possible embodiments. Embodiments are not limited to the specific implementations, arrangements, displays, features, approaches, or scenarios provided herein. A given embodiment may include additional or different features, mechanisms, and/or data structures, for instance, and may otherwise depart from the examples provided herein.

During an information acquiring step 302, an embodiment acquires service provisioning information 204. Step 302 may be accomplished using networks 108 (computer or telecommunications), keyboards and other peripherals 106, database reads or search engine results to access previously provided information, and/or other mechanisms, for example.

During a bid obtaining step 304, an embodiment acquires referral bid(s) 206. Step 304 may be accomplished using networks 108, keyboards and other peripherals 106, database reads to access previously provided information, and/or other mechanisms, for example.

During a request receiving step 306, an embodiment receives a service request 222. Step 306 may be accomplished using networks 108, keyboards and other peripherals 106, database reads to access previously provided information, and/or other mechanisms, for example.

During a candidate determining step 308, an embodiment determines a set 310 of candidate 244 service providers. Step 308 may be accomplished using processor(s) 110 and memory under control of a broker 248, for example.

In one embodiment, request criteria 226 and provisioning information 204 are given relative weights which multiply their numeric values, and a provider is determined to be a candidate if the sum of the provider's skills, experience, etc.

times their respective weights equals or exceeds the sum of the corresponding skills, experience, etc. in the service request times their respective weights. Thus, a deficiency in one desired aspect may be overcome by sufficient qualifications in another aspect. In other embodiments, request criteria 226 and provisioning information 204 are compared one-by-one, and a deficiency in any aspect rules out a provider as a candidate, even if the provider is overqualified in other aspect(s). Other combinations may also be used, e.g., a provider may be determined 308 to be a candidate if the provider satisfies at least three of five specified criteria 226.

During a recommended provider selecting step 312, an embodiment selects one or more recommended providers 246 from among candidate 244 service providers. Step 312 may be accomplished using processor(s) 110 and memory under control of a broker 248, for example. In some embodiments, steps 308 and 312 are combined. For instance, one embodiment selects as the recommended provider the first N providers, found in an automated review of all provider provisioning information records, that meet or exceed the request criteria 226.

During a recommendation sending step 316, an embodiment sends a recommendation 320 to a service consumer. Step 316 may be accomplished using networks 108 to carry the recommendation to a consumer's device 102, for example. The recommendation may be implemented in HTML, XML, or another familiar format for computer systems 102, and in displayable text or synthesized speech for a consumer's phone device 102, for example. The recommendation identifies the recommended provider(s) by name, and may provide contact information for direct contact or may request or require that the consumer go through the broker 248 to contact the recommended provider(s).

During an assignment details sending step 318, an embodiment sends details 322 of a task assignment to a service provider. Step 318 may be performed contemporaneously with step 316, or may be performed only if the consumer accepts the recommendation made in step 316. Step 318 may also be performed in the absence of step 316, e.g., in embodiments that rely on prior agreement of the consumer to an arrangement which proceeds directly to task assignment once a recommended provider is automatically selected. Step 318 may be accomplished using networks 108 to carry the details 322 to a provider's device 102, in HTML, XML, or another familiar format for computer systems 102, and in displayable text or synthesized speech for phone devices 102, for example.

During a reputation value deriving step 324, an embodiment derives a reputation 218 for a service provider. Reputation 218 may be per-service, e.g., a provider may have one reputation as a barber for men and a different reputation as a hair stylist for women. Reputation 218 may also be overall, for all services offered by the provider. Reputation 218 may be represented by a letter grade (A, B, C, etc.), an enumeration (favorite, respected, qualified, etc.), a percent of satisfied consumers, or any other value which is presented as, or can be mapped to, a numeric value, for example. Reputation 218 may be derived by averaging scores given in reviews by past consumers, for example, or by mapping a rating given by an organization onto a numeric reputation value. Familiar mechanisms for deriving reputation from community input may be adapted for use deriving service provider reputations 218.

During a considering step 326, an embodiment utilizes, displays information pertaining to, selects, or otherwise considers a composite service provider 328. A composite service provider may be, for instance, a provider composed of a business and also one or more employees of the business. Different components of a composite provider 328 may offer different services, have different reputations, make different referral bids, and so on, but still be presented together to consumers in recommendations.

During a ranking step 330, an embodiment ranks recommended providers according to the strength with which they are being recommended to a consumer for a given task. For example, providers may be ranked by decreasing reputation 218, decreasing proximity to the task location, increasing ask price 216, or any other set of one or more criteria.

During a payment accepting step 332, an embodiment accepts a payment from a service provider, such as a referral fee or a subscription or listing fee. Step 332 may be accomplished using electronic funds transfer, credit cards, or another familiar payment mechanism, for example.

During a payment sharing step 334, an embodiment shares with a consumer a payment received from a service provider, such as a rebate. Step 334 may be accomplished using electronic funds transfer, gift cards, credit cards, or another familiar payment mechanism, for example.

During an eliminating step 336 within determining step 308 and/or selecting step 312, an embodiment eliminates from further consideration one or more service providers whose referral fee bids 206 were lower than other providers being considered for a task.

During a reciting step 338, an embodiment recites in a recommendation 320 a description of the service criteria 226 and the matching service provisioning information 204 for a service provider, who may be a currently recommended provider, for example, or a provider that is not currently recommended but has been recommended in the past.

During a displaying step 340, an embodiment displays to a consumer review(s) 240 of service provider(s). “Display” may be accomplished using web pages, other graphical displays, synthesized or recorded speech, video recordings, email or messaged text, or another communication mechanism, for example.

During a response getting step 342, an embodiment gets a consumer's response 346 to a recommendation 320, indicating whether a recommended service provider is accepted by the consumer. Step 342 may be accomplished using web forms, email, text messages, and networks 108, for example.

During a response noting step 344, an embodiment notes a provider's response 348 to a task assignment 352, indicating whether the assignment provider is accepted by the provider. Step 344 may be accomplished using web forms, email, text messages, and networks 108, for example.

During an assignment transmitting step 350, an embodiment transmits a task assignment 352 to a provider. The task assignment identifies the task 224. Additional details 322 may be sent in the task assignment or separately, including for instance, consumer contact information, comments or updates from the consumer, links to local resources, and so on. Some embodiments transmit 350 task assignments or portions thereof to consumers as well, and some display the details on a consumer dashboard. Step 350 may be accomplished using networks 108, for example.

During a discount transmitting step 354, an embodiment transmits a coupon, discount code, or other discount 356 to a consumer. Step 354 may be accomplished using discount databases, customer loyalty software, and networks 108, for example.

During an acceptance logging step 358, an embodiment logs into a file or database an acceptance 360 of a task assignment by a provider.

During a rejection noting step 362, an embodiment notes that a provider has reached a rejection threshold 364 by rejecting a predetermined number of task assignments in a specified time period. During a notifying step 368, an embodiment notifies a human administrator 370 of the event 366, e.g., by email or text message, so that the administrator is prompted to investigate if desired the reasons for repeated refusal to accept task assignments.

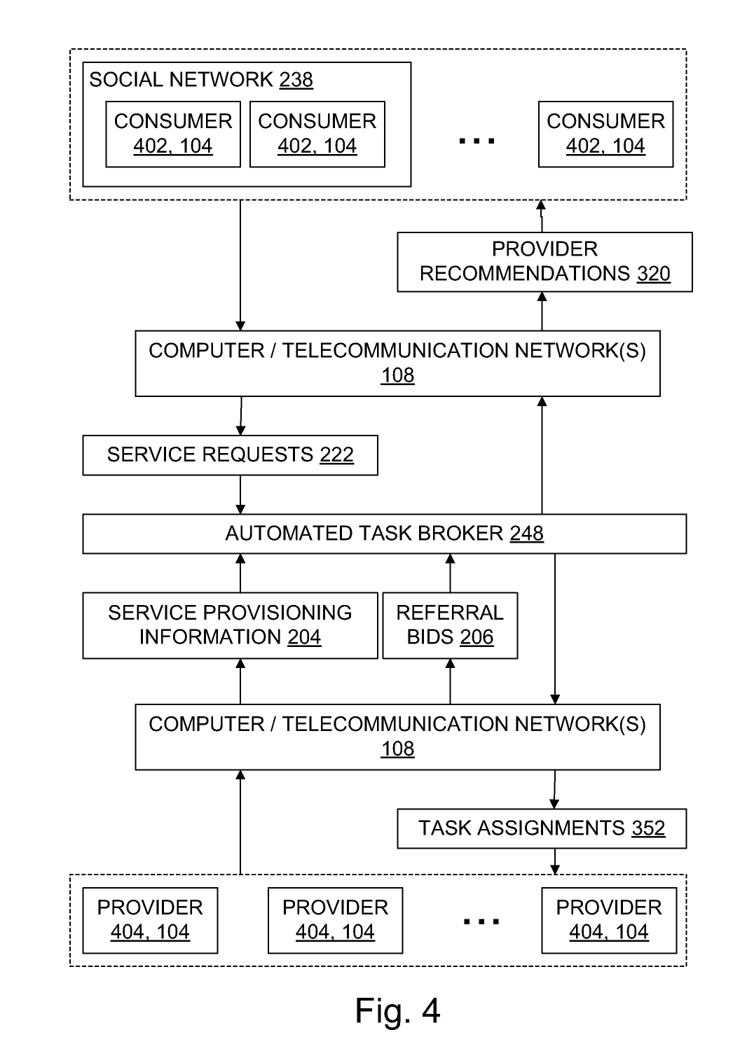

FIG. 4 further illustrates contextual task assignment. Service requests 222 flow from service consumers 402 through networks 108 to a task broker 248. Service provisioning information 204 and referral fee bids 206 flow from service providers 404 through networks 108 to the task broker 248. The task broker sends provider recommendations 320 to the consumers 402, and sends task assignments 352 to the service providers 404. Internal operation of the task broker 248 proceeds as discussed herein, e.g., by comparing service requests 222 with service provisioning information 204 to select 312 providers to recommend.

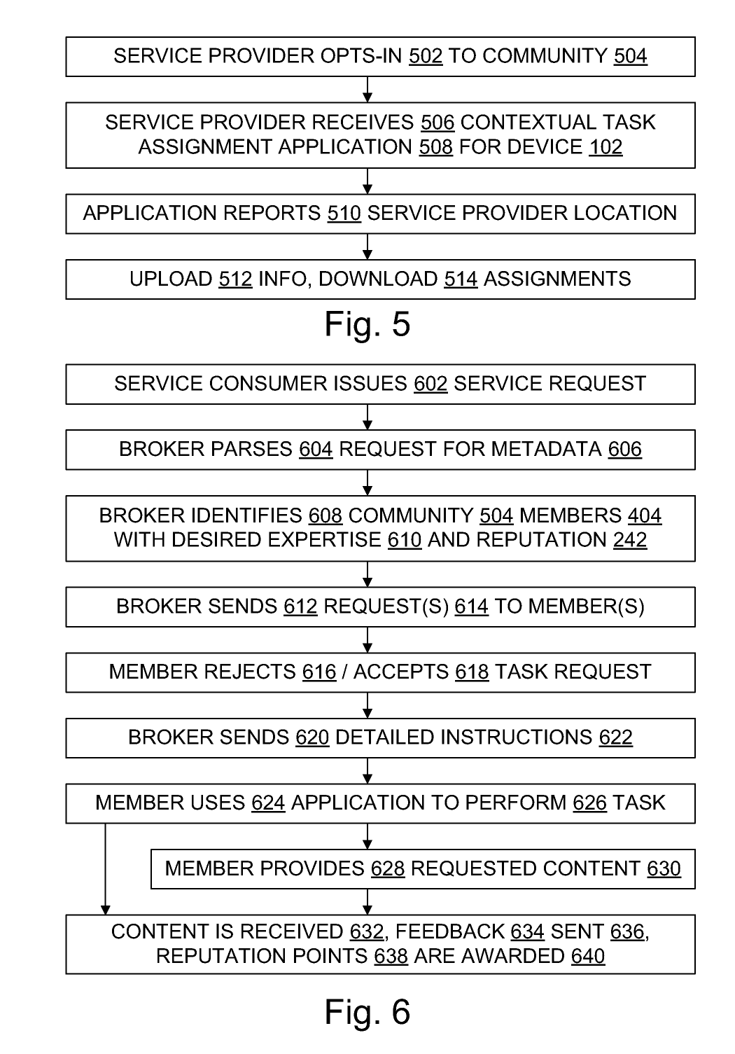

FIG. 5 illustrates how a service provider 404 becomes known to a contextual task assignment broker 248 in some embodiments, thereby building a pool of potential task assignees. A service provider opts-in 502 to an online community of providers 404 and consumers 402. The service provider receives 506 contextual task assignment software, such as an application 508 that is executable on a smart phone, computer, or other device 102. The application reports 510 the service provider's location 214 to the broker 248, through GPS and/or other geo-location technologies, for example. Service providers available at multiple locations may manually supplement the automatic location report. In some embodiments, service provisioning information 204 may also be uploaded 512 to the broker 248, and task assignments may be downloaded 514 from the broker 248.

FIG. 6 further illustrates contextual processing of a service request from its issuance through to service completion. A service consumer 402 issues 602 a service request 222, which is received 306 by a task broker 248. The broker 248 may be in the form of a program or specialized circuitry. The broker 248 parses 604 the request to extract metadata 606, such as what task 224 is requested, service criteria 226, the service consumer ID 220, and possibly other items such as the date/time of the request, and the communication channel used to send the request, which may be presumed to be the best channel for communication with the consumer about this request.

The broker 248 identifies 608 community 504 members (specifically, service providers 404) who have the desired expertise 610 (e.g., skills 228 and experience 230) to perform the task, and who also have the desired reputation 242. For instance, the broker may determine 308 a set 310 of candidates 244 and then select 312 a provider from that set 310, or the broker 248 may select 312 a provider from among all community members. The broker 248 sends 612 task request(s) 614 to the identified 608 member(s), possibly after sending 316 a recommendation 320 to the consumer 402 and getting 342 the consumer's response 346 approving the recommended member(s). The task request 614 may be a subset of the service request 222, e.g., in some embodiments the task request includes the task 224, schedule 232, proximity 234, and price 236 requirements.

The member rejects 616 or accepts 618 the task request 614, and the broker 248 notes 344 that response 348. If the task request is rejected (explicitly or as result of a failure to respond after a specified point in time or period of time has passed), and the rejection exceeds a rejection threshold 364, then the broker 248 may notify 368 a human administrator 370 to prompt appropriate follow-up. For instance, the service provider may have gone out of business, or stopped providing particular services, or have an unresolved compliant about a past assignment.

If the task request is accepted, then the broker may send 620 detailed instructions 622, such as a local contact, a password, a change in route or schedule or personnel, key objectives, or any other pertinent information the consumer deems appropriate. A task assignment 352 may include a task request 614, detailed instructions 622, or both. Transmission 350 of a task assignment may include sending 612 a task request, sending 620 detailed instructions, or both.

In some embodiments, the service provider member uses 624 the application 508 to perform 626 the task 224. For instance, some tasks seek technical information, legal advice, music, video, writings, artwork, designs, or other content 630 that can be captured and provided 628 in digital form by the service provider. After the content 630 is received 632, either by the consumer 402 or by a mutually-agreed-upon agent representing the consumer 402, or the task has otherwise been performed 626, the consumer sends 636 feedback 634 to the broker 248, such as a review 240 of the service provider and/or comments about the task broker's effectiveness. Reputation points 638 are then derived 324 and awarded 640 to the service provider by the broker 248.

The foregoing steps and their interrelationships are discussed in greater detail below, in connection with various embodiments.

Some embodiments provide a brokering process for contextual assignment of a task. The process includes electronically acquiring 302 service provisioning information from a plurality of service providers, electronically obtaining 304 bids from the service providers indicating respective amounts the service provider will pay for a referral, and electronically receiving 306 a service request from a service consumer. In the service request, the service consumer indicates what service(s) the consumer is seeking, and in the provisioning information the service provider indicates what service(s) are being offered.

The process also includes determining 308 a set of candidate service providers by matching criteria in the service request with service provisioning information of respective service providers, and selecting 312 a recommended service provider from among the candidate service providers based on bids obtained from the candidate service providers. In some embodiments, selecting a recommended service provider includes eliminating 336 any low-bid service providers, and then selecting from the remaining candidates a highest-reputation service provider. Some select 312 a recommended service provider from among the candidate service providers based at least on reviews of the service provider by members of a social network that is specified by the service consumer. Some embodiments also send 316 a recommendation to the service consumer referring the service consumer to the recommended service provider; some assign the task directly after selecting a provider, based on pre-approval by the consumer.

In some embodiments, determining 308 a set of candidate service providers uses at least one of the following criteria. One, a service provider reputation value derived from reviews by a community of service consumers. Two, a service provider reputation value derived from a rating issued by an organization. Three, geographic proximity of the service provider to a task location, e.g., to find a plumber nearby or get a tow truck near a broken down car. The task may be at a different location than the service consumer. Four, particular skills of the service provider, e.g., language fluency, equipment familiar with, professional license, and so on. Five, particular experience of the service provider, e.g., five years writing test scripts, ten years driving a big rig, and so on. Six, an availability schedule of the service provider. Seven, an ask price, namely, a price the service provider is asking to be paid by the service consumer, and eight, an offer price, namely, a price the service consumer is offering to pay for the service.

In some embodiments, the recommended service provider is a composite service provider, namely, a business and an employee of the business. Accordingly, a referral bid might be submitted to the broker 248 either by the employee or by the business.

In some embodiments, the process selects 312 multiple recommended service providers, e.g., from among the candidate service providers based on bids obtained from the candidate service providers, and sends 316 at least one recommendation to the service consumer. The recommendation(s) collectively refer the service consumer to multiple recommended service providers, who may be ranked 330 in order by recommendation strength.

In some embodiments, the broker 248 accepts 332 a payment from the recommended service provider based on the bid previously obtained from the recommended service provider. For example, embodiments may be used with for-profit businesses and also help non-profits connect with unpaid volunteers. In some embodiments, the broker shares 334 with the service consumer a payment from the recommended service provider. The payment may be based on the bid previously obtained from the recommended service provider, or other factors. Some embodiments transmit 354 a discount such as a coupon or a discount code redeemable with the service provider.

Some embodiments provide a brokering process for contextual assignment of a task, which includes electronically acquiring 302 service provisioning information from a plurality of service providers, electronically obtaining 304 bids from the service providers indicating respective amounts the service provider will pay for a referral, and electronically receiving 306 a service request from a service consumer. The process also includes determining 308 a set of candidate service providers by matching criteria in the service request with service provisioning information of respective service providers, and selecting 312 a recommended service provider from among the candidate service providers based on at least one of the following: bids obtained from the candidate service providers, data provided to the broker by former consumers of the service providers, reviews of the service provider by members of a specified social network.

Some embodiments of any of these processes include sending 316 a recommendation to the service consumer which recites 338 the criteria in the service request and also recites 338 the matching service provisioning information of the recommended service provider. Some display 340 to the service consumer reviews of the service provider, which were entered by other service consumers to whom the service provider was recommended. In some embodiments, a response 346 from the service consumer indicates whether the recommended service provider is accepted or rejected.

Some embodiments include transmitting 350 to the recommended service provider a task assignment based on the service request, and noting 344 a response 348 from the service provider. The response 348 may indicate that the task assignment is accepted, a reason this task assignment is accepted, criteria for accepting task assignments generally, or the response may indicate that the task assignment is rejected, a reason this task assignment is rejected, and/or criteria for rejecting task assignments generally, for example. Some embodiments log 358 an acceptance of a task assignment. Some send details of the service provider to a service consumer dashboard. In some embodiments, the process may note 362 that rejection threshold event has occurred, namely, a predetermined number of task rejections by a service provider have occurred within a specified time period, and automatically notify 368 a human administrator of the rejection threshold event.

In some embodiments, the broker 248 receives 306 an incoming request from an individual (known or unknown) and facilitates the receipt of contextual information including geography of the requestor and metadata 606 tags about the request. The broker 248 then automatically evaluates the contextual information for the request against the reputation 218 and/or skills 208 of individuals within a desired geographic proximity 234 and issues requests 614 for engagement to the appropriate parties. The individuals assigned the task are selected 312 from a pool of both staff and crowdsourced volunteers, and are provided with software 508 to transmit back content 630 related to the assignment (image, video, audio, text, etc.). Thus, some embodiments use geographic proximity and reputation to assign crowd resources to perform a task.

Some of the many possible example scenarios include a news organization crowdsourcing assignment of data collection/reporting for a breaking story; tasking roadside assistance for an individual who is on the side of the road to a tow truck nearby (based on proximity, familiarity with car, availability, and user reviews as context); and finding a hair stylist for an individual, based on proximity, availability, price range, service to be performed such as cut and color, and reviews that provide context.

In some embodiments, the broker 248 provides multiple interfaces for individuals to initiate a request 222. The request can take the form of a phone call, SMS text message, MMS multimedia message, email, web based form, mobile phone application, or social network posting, for example. An individual places a request using one of these interfaces and populates a request with criteria 226. In addition to storing the content detail in its entirety, the broker 248 extracts contextual information and stores it as metadata 606 tags. In addition, the geographic location of the consumer is recorded. The broker 248 system acknowledges receipt of the request and initiates a workflow that will determine the appropriate individual(s) to respond. In view of the possibility that most of the requests will be of a time sensitive nature, some embodiments will determine individuals who are the most skilled/knowledgeable within the general proximity.

The pool of individuals that will be used in this determination are ones that are other members of the community 504, at least in some embodiments. The community includes both staff and volunteer members (“crowdsourcing community”). Upon joining the community, members of this pool opt-in 502 to provide their geographic location via one or more communication mechanisms; location may be provided automatically via software 508 running on a device 102 (phone, computer, MP3 player, automobile, etc.).

Each member of the community has a reputation 218 within the community—either issued by the organization (organization issued reputation) or as a result of past engagement as a member of the crowdsourcing community (merit issued reputation). In addition to a reputation, an individual has a number of descriptive metadata tags (e.g., provisioning information 204) that identify their areas of subject matter expertise. For a reporter, metadata might include “state legislature”, for a technician it might include “Satellite TV installation”, and so on. The broker 248 solution looks at the geolocation of the report, the related metadata tags, and identifies 608 the closest individual(s) with the appropriate subject matter expertise and the highest reputation. Upon finding the appropriate individual(s) the solution issues requests 614 for their engagement, which may be visualized on a device (e.g. phone) or delivered via an automated voice system powered by software.

Individual(s) will choose to accept 618 or reject 616 the requests for engagement. If rejected, the system will continue to contact other members in the pool based on proximity. If accepted, the acceptance will be acknowledged and logged 358 in the system. The details of the individual(s) accepting the request are sent to a dashboard which can be reviewed by service consumer organizational staff and potentially utilized for direct contact to the accepting individual(s) with further instructions. Once a pre-determined number of rejections occur, the solution notifies 368 a person within the organization for manual intervention in the workflow. Individuals accepting the requests can utilize a portable software application, phone or device based, to collect information from the scene of the event (images, audio, video, sensor information) and transmit that content 630 directly back to the organization via a software client.

Configured Media

Some embodiments include a configured computer-readable storage medium 112. Medium 112 may include disks (magnetic, optical, or otherwise), RAM, EEPROMS or other ROMs, and/or other configurable memory, including in particular non-transitory computer-readable media (as opposed to wires and other propagated signal media). The storage medium which is configured may be in particular a removable storage medium 114 such as a CD, DVD, or flash memory. A general-purpose memory, which may be removable or not, and may be volatile or not, can be configured into an embodiment using items such as service provisioning information 204, service requests 222, and automated brokers 248, in the form of data 118 and instructions 116, read from a removable medium 114 and/or another source such as a network connection, to form a configured medium. The configured medium 112 is capable of causing a computer system to perform process steps for transforming consumer and provider metadata through contextual task assignment and follow-up as disclosed herein. FIGS. 1 through 6 thus help illustrate configured storage media embodiments and process embodiments, as well as system and process embodiments. In particular, any of the process steps illustrated in FIGS. 3 through 6, or otherwise taught herein, may be used to help configure a storage medium to form a configured medium embodiment.

Conclusion

Although particular embodiments are expressly illustrated and described herein as processes, as configured media, or as systems, it will be appreciated that discussion of one type of embodiment also generally extends to other embodiment types. For instance, the descriptions of processes in connection with FIGS. 3 to 6 also help describe configured media, and help describe the operation of systems and manufactures like those discussed in connection with other Figures. It does not follow that limitations from one embodiment are necessarily read into another. In particular, processes are not necessarily limited to the data structures and arrangements presented while discussing systems or manufactures such as configured memories.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific features of an example may be omitted, renamed, grouped differently, repeated, instantiated in hardware and/or software differently, or be a mix of features appearing in two or more of the examples. Functionality shown at one location may also be provided at a different location in some embodiments.

Reference has been made to the figures throughout by reference numerals. Any apparent inconsistencies in the phrasing associated with a given reference numeral, in the figures or in the text, should be understood as simply broadening the scope of what is referenced by that numeral.

As used herein, terms such as “a” and “the” are inclusive of one or more of the indicated item or step. In particular, in the claims a reference to an item generally means at least one such item is present and a reference to a step means at least one instance of the step is performed.

Headings are for convenience only; information on a given topic may be found outside the section whose heading indicates that topic.

All claims as filed are part of the specification.

While exemplary embodiments have been shown in the drawings and described above, it will be apparent to those of ordinary skill in the art that numerous modifications can be made without departing from the principles and concepts set forth in the claims. Although the subject matter is described in language specific to structural features and/or procedural acts, it is to be understood that the subject matter defined in the appended claims is not necessarily limited to the specific features or acts described above the claims. It is not necessary for every means or aspect identified in a given definition or example to be present or to be utilized in every embodiment. Rather, the specific features and acts described are disclosed as examples for consideration when implementing the claims.

All changes which come within the meaning and range of equivalency of the claims are to be embraced within their scope to the full extent permitted by law.

What is claimed is:

1. A brokering process for contextual assignment of a task, the process utilizing a device which has at least one logical processor in operable communication with at least one memory, the process comprising the steps of:
electronically acquiring service provisioning information from a plurality of service providers;
electronically obtaining bids from the service providers indicating respective amounts the service provider will pay for a referral;
electronically receiving a service request from a service consumer;
determining a set of candidate service providers by matching criteria in the service request with service provisioning information of respective service providers;
selecting a recommended service provider from among the candidate service providers based on bids obtained from the candidate service providers; and
sending a recommendation to the service consumer referring the service consumer to the recommended service provider.

2. The process of claim 1, wherein the step of determining a set of candidate service providers uses at least one of the following criteria:
a service provider reputation value derived from reviews by a community of service consumers;
a service provider reputation value derived from a rating issued by an organization;
geographic proximity of the service provider to a task location;
particular skills of the service provider;
particular experience of the service provider;
an availability schedule of the service provider;
an ask price, namely, a price the service provider is asking to be paid by the service consumer;
an offer price, namely, a price the service consumer is offering to pay for the service.

3. The process of claim 1, wherein the recommended service provider is a composite service provider, namely, a business and an employee of the business.

4. The process of claim 1, wherein the process comprises:
selecting multiple recommended service providers from among the candidate service providers based on bids obtained from the candidate service providers; and
sending at least one recommendation to the service consumer, the recommendation(s) collectively referring the service consumer to multiple recommended service providers ranked in order by recommendation strength.

5. The process of claim 1, further comprising accepting a payment from the recommended service provider based on the bid previously obtained from the recommended service provider.

6. The process of claim 1, further comprising sharing with the service consumer a payment from the recommended service provider, the payment being based on the bid previously obtained from the recommended service provider.

7. The process of claim 1, wherein the step of selecting a recommended service provider comprises eliminating any low-bid service providers, and then selecting from the remaining candidates a highest-reputation service provider.

8. A computer-readable non-transitory storage medium configured with data and with instructions that when executed by at least one processor causes the processor(s) to perform a brokering process for contextual assignment of a task, the process comprising the steps of:
electronically acquiring service provisioning information from a plurality of service providers;
electronically obtaining bids from the service providers indicating respective amounts the service provider will pay for a referral;
electronically receiving a service request from a service consumer; and
selecting a recommended service provider from among the candidate service providers based on at least one of the following:
bids obtained from the candidate service providers;
data provided to the broker by former consumers of the service providers;
reviews of the service provider by members of a specified social network;
criteria in the service request corresponding with service provisioning information of respective service providers.

9. The configured medium of claim 8, further comprising sending a recommendation to the service consumer reciting the criteria in the service request and also reciting the matching service provisioning information of the recommended service provider.

10. The configured medium of claim 8, wherein the process further comprises displaying to the service consumer reviews of the service provider, the reviews previously entered by other service consumers to whom the service provider was recommended.

11. The configured medium of claim 8, wherein the process further comprises sending a recommendation to the service consumer, and getting a response from the service consumer indicating one of the following:
the recommended service provider is accepted;
the recommended service provider is rejected.

12. The configured medium of claim 8, wherein the process further comprises transmitting to the recommended service provider a task assignment based on the service request, and noting a response from the service provider indicating at least one of the following:
the task assignment is accepted;
a reason this task assignment is accepted;
criteria for accepting task assignments generally;
the task assignment is rejected;
a reason this task assignment is rejected;
criteria for rejecting task assignments generally.

13. The configured medium of claim 8, wherein the process further comprises transmitting at least one of the following: a coupon, a discount code redeemable with the service provider.

14. The configured medium of claim 8, wherein the step of selecting a recommended service provider from among the candidate service providers selects the recommended service provider based at least on reviews of the service provider by members of a social network that is specified by the service consumer.

15. The configured medium of claim 8, wherein the process further comprises at least one of the following:
logging an acceptance of a task assignment;
sending details of the service provider to a service consumer dashboard.

16. The configured medium of claim 8, wherein the process further comprises noting that rejection threshold event has occurred, namely, a predetermined number of task rejections by a service provider have occurred within a specified time period, and automatically notifying a human administrator of the rejection threshold event.

17. A computer system comprising:
a logical processor;
a memory in operable communication with the logical processor, the memory containing:
service provisioning information for each of a plurality of service providers;
bids from the service providers indicating respective amounts the service provider will pay for a referral;
a service request from a service consumer, the service request containing service criteria; and
a contextual task assignment broker operable to determine a set of candidate service providers and produce a selection of a recommended service provider from among the candidate service providers.

18. The system of claim 17, wherein the memory also contains a social network identification, and reviews of the recommended service provider by members of the social network, and wherein the service criteria comprise a minimum acceptable service provider reputation value derived from the reviews.

19. The system of claim 17, wherein the service criteria comprise at least two of the following criteria:
a service provider reputation value derived from reviews by a community of service consumers;
a service provider reputation value derived from a rating issued by an organization;
geographic proximity of the service provider to a task location;
particular skills of the service provider;
particular experience of the service provider;
an availability schedule of the service provider.

20. The system of claim 17, wherein the contextual task assignment broker is operable to determine a set of candidate service providers at least in part by eliminating lowest-bid service provider(s) as candidates.
